(19) United States
(12) Patent Application Publication
(10) Pub. No.: US 2008/0238359 A1
(43) Pub. Date: Oct. 2, 2008

(54) Lithium Iron Phosphate Ultra Fast Battery Charger

(75) Inventors: Jordan T. Bourilkov, Stamford, CT (US); David N. Klein, Southbury, CT (US); John Rotondo, Trumbull, CT (US); Leslie J. Pinnell, Framingham, MA (US); George M. Cintra, Holliston, MA (US); Kirakodu S. Nanjundaswamy, Sharon, MA (US)

Correspondence Address: FISH & RICHARDSON P.C., P.O. BOX 1022, MINNEAPOLIS, MN, 55440-1022, US

(73) Assignee: The Gillette Company

(21) Appl. No.: 11/775,966

(22) Filed: Jul. 11, 2007

Related U.S. Application Data
(60) Provisional application No. 60/908,013, filed on Mar. 26, 2007.

(51) Int. Cl. H02J 7/04; H01M 10/44

(52) U.S. Cl. 320/107; 320/157

(57) ABSTRACT

Chargers for charging a rechargeable battery determine a current level to apply to the rechargeable battery such that the battery has a pre-determined charge that is reached within a charging period of time of between 4-6 minutes and apply a charging current having substantially about the determined current level to battery and terminating the charging current after a period of charging time substantially equal to the particular period of time has elapsed.

### CROSS-REFERENCE TO RELATED APPLICATIONS

This application claims priority to U.S. Provisional Application Ser. No. 60/908,013, entitled “Lithium Iron Phosphate Ultra Fast Battery Charger” and filed on Mar. 26, 2007, the content of which is hereby incorporated by reference in its entirety.

### BACKGROUND

Rechargeable batteries are typically charged by a source of constant voltage/constant, current CV/CC) with crossover voltage, e.g., at 4.2V. Initially, the battery is charged using a constant current (i.e., in CC mode) until the crossover point is reached (e.g., 4.2V), at which point the charger switches to constant voltage mode to maintain the voltage at the terminal of the rechargeable battery at substantially about the crossover voltage. The charging period required to achieve 90-100% capacity is typically 2-4 h, with the CC stage being around 40 minutes at 1 C charging rate (i.e., a charging rate corresponding to a charging current level that would charge a battery in one hour). Generally, at the conclusion of the CC stage the rechargeable battery achieves a charge level of 60-70% of the charge capacity of the battery. The CV stage of the charging process generally takes 1-3 hours to complete. During that time the charging current level decreases and typically reaches a level corresponding to a charge rate of 0.1 C by the time the charging process is concluded.

One factor limiting the expediency of the charging rechargeable batteries is the danger of causing the charger and/or battery to overheat. Such overheating may damage the charger and/or battery, and further pose a safety risk. Consequently, conventional chargers are configured to apply charging current corresponding to charge rates of about 1 C. To protect against overheating conditions, temperature sensors are sometimes used to monitor the temperature of the charger and/or the battery, thus enabling the charger to undertake remedial or preemptive actions in the event of the detection of overheating conditions (e.g., terminating the charging current if the battery's temperature exceeds a safety limit of, for example, 45° C.)

### SUMMARY

Disclosed is charger configured to charge a rechargeable battery in approximately 4-6 minutes to approximately 90-95% capacity.

In an aspect, a method for charging a rechargeable battery includes determining a current level to apply to the rechargeable battery such that the battery has a pre-determined charge that is reached within a charging period of time of between 4-6 minutes, applying a charging current having substantially about the determined current level to battery and terminating the charging current after a period of charging time substantially equal to the particular period of time has elapsed.

The follow are embodiments within the scope of this aspect.

The method includes periodically adjusting the charging current after a pre-determined voltage level at terminals of the rechargeable battery is reached to maintain the voltage between terminals of the rechargeable battery at the pre-determined voltage level. The method includes causing an output indicator device to be activated when the pre-determined voltage level at terminals of the rechargeable battery is reached. The pre-determined charge of the cell is at least 80% of the charge capacity of the rechargeable battery, and wherein the charging period of time is approximately 3-4 minutes. The pre-determined charge of the rechargeable battery is at least 90% of the charge capacity of the rechargeable battery, and wherein the charging period of time is approximately 3 minutes. The method includes applying the charging current without monitoring temperatures of the rechargeable battery. Applying the charging current includes regulating current provided by a power conversion module having a voltage transformer section. Regulating the current provided by the power conversion module includes regulating the operation of the voltage transformer section. Determining the current level to apply to the rechargeable battery includes determining the current level to apply to a rechargeable lithium-iron-phosphate-based battery.

In an additional aspect, a charger device to charge one or more rechargeable batteries includes a receptacle to receive one or more rechargeable batteries, the receptacle having electrical contacts configured to be coupled to respective terminals of the one or more rechargeable batteries and a controller configured to determine a current level to apply to the one or more rechargeable batteries such that the one or more batteries have a pre-determined charge that is reached within a charging period of time of between 4-6 minutes, apply a charging current having substantially about the determined current level to the one or more rechargeable batteries and terminate the charging current after a period of charging time substantially equal to the particular period of time has elapsed.

The follow are embodiments within the scope of this aspect.

The pre-determined charge of the one or more batteries is at least 80% of the charge capacity of the one or more cells, and wherein the charging period of time is approximately between 3-15 minutes. The pre-determined charge of the one or more rechargeable batteries is approximately 80% of the charge capacity of the one or more batteries, and wherein the charging period of time is approximately between 3-4 minutes. The pre-determined charge of the one or more rechargeable batteries is at least 90%-95% of the charge capacity of the one or more batteries, and wherein the specified period of time is approximately 5 minutes. The device includes a power conversion module, the power conversion module including a voltage transformer. The device includes a feedback control mechanism to cause the controller to regulate current outputted by the power conversion module. The feedback control mechanism is configured to regulate the operation of the voltage transformer. The feedback control mechanism is configured to maintain the voltage at the terminals of the one or more rechargeable batteries at a pre-determined upper limit voltage, after the voltage at the one or more batteries reach the pre-determined upper-limit voltage level. The device includes an output indicator device, with the controller configured to cause the output indicator device to be activated when the pre-determined voltage level at terminals of the rechargeable battery is reached. The device includes a MOSFET-transistor-based synchronous rectifier. The controller is configured to determine the current level to apply to one or more lithium-iron-phosphate-based rechargeable batteries. The controller includes a processor-based micro-controller. The controller configured to apply the charging current is configured to apply the charging current without monitoring temperatures of the one or more rechargeable batteries.

In an additional aspect, a charger device includes electrical contacts configured to couple to respective terminals of one or more rechargeable batteries, circuitry to charge the one or more batteries by applying a constant charging current to the one or more rechargeable batteries upon commencement of the charging operation and to maintain a constant voltage on the one or more batteries when the voltage of the one or more batteries reaches a pre-determined upper limit voltage and a controller configured to control the circuitry, the controller configured to cause the circuitry to charge to the battery for charging period of time of between 4-6 minutes and to thereafter terminate charging of the battery.

In an additional aspect, a charger device includes electrical contacts configured to couple to respective terminals of one or more rechargeable batteries and circuitry to charge the one or more batteries by measuring existing charge in the battery, determining a period of time over which to apply charging current, applying a charging current to the one or more rechargeable batteries upon commencement of the charging operation over the determined charging period of time.

One or more aspects may provide one or more of the following advantages.

Using the relatively low internal resistance of e.g., lithium-phosphate batteries, the batteries can be charged to approximately 80% capacity in constant current (CC) mode in 3-4 minutes, and can be charged to approximately 90-95% capacity in 5 min. The charger is configured to terminate the charging operation after a determined or specified time period has elapsed without having to perform any checks to determine the charge or voltage level of the battery or to perform thermal monitoring and/or thermal control operations. This configuration minimizes circuitry needed, thermal heat sinking needed and so forth, thus reducing cost and size of the charger.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary embodiment of a charger.

FIG. 1A is a flow chart depicting an embodiment with variable timing.

FIG. 2 is a flow chart, of an exemplary embodiment of a charging procedure performed by the charger of FIG. 1.

FIGS. 3A-B are graphs showing the charging voltage and charging current behaviors for a 1 Ah lithium-ion battery using the charger of FIG 1.

### DETAILED DESCRIPTION

Electrochemical cells can be primary cells or secondary cells. Primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995). On the other hand, secondary electrochemical cells, also referred to below as rechargeable cells or batteries, can be recharged many times, e.g., fifty times, a hundred times, and so forth. Secondary cells are described, e.g., in Falk & Salkind, “Alkaline Storage Batteries”, John Wiley & Sons, Inc. 1969; U.S. Pat. No. 345,124; and French Patent No. 164,681, all hereby incorporated by reference.

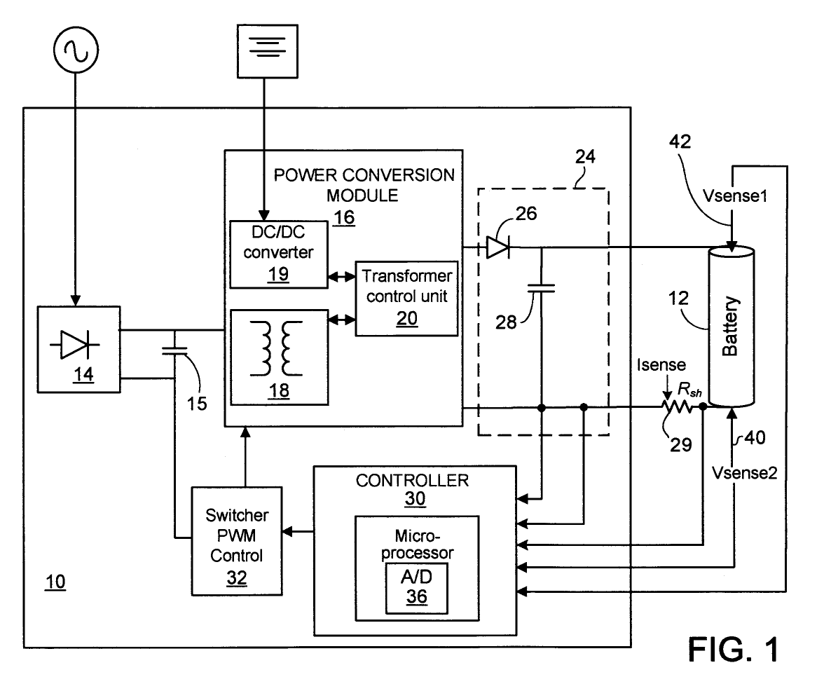

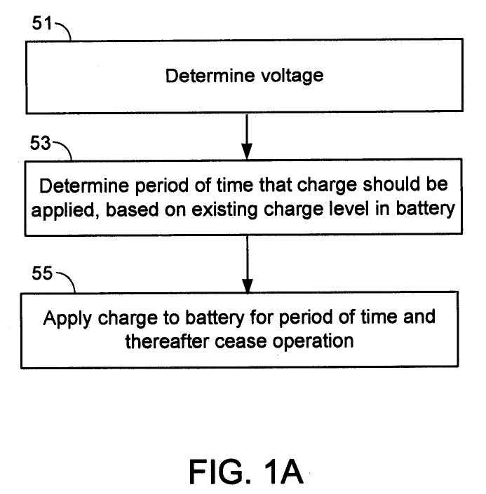

Referring to FIG. 1, a charger 30 configured to charge a rechargeable battery 12 having at least one rechargeable electrochemical based on lithium-iron-phosphate chemistry is shown. Such a battery (which is sometimes referred to as a secondary battery) includes cells having, in some embodiments, lithium titanate anode material, and lithiated-iron-phosphate cathode materials adapted to enable fast recharge of rechargeable batteries based on such materials. Lithium-iron-phosphate chemistry has low internal resistance (R). Thermal dissipation resulting from the internal resistance of such batteries is proportional to IR² (where I is the charging current applied to the battery). Because of the low internal resistance of batteries based on lithium-iron-phosphate chemistry, such batteries can accept high charging currents.

Accordingly, using low internal resistance batteries, such as lithium-iron-phosphate batteries, the batteries can be charged to approximately 80% capacity in constant current (CC) mode in 3-4 minutes, and can be charged to approximately 90-95% capacity in 5 min. As will become apparent below, the use of a large charging current to charge a battery based on lithium-iron-phosphate chemistry generally results in the battery achieving 90-95% charge capacity within five (5) minutes, and accordingly, the charger is configured to terminate the charging operation after that time period has elapsed without having to perform any checks to determine the charge or voltage level of the battery, or to perform thermal monitoring and/or thermal control operations. The charger may use a timer to measure to charge period and terminate the charging operation upon the timer reaching the pre-specified charge time period, e.g., 5 minutes. Although FIG. 1 shows a single battery 12 connected to the charger 10, the charger 10 may be configured to have additional batteries connected to it. Further, the charger 10 may be configured to receive and charge different battery types including cylindrical batteries, prismatic batteries, coin or button batteries, etc.

The charger 10 is configured to apply a constant charging current to the battery upon commencement of the charging operation. During the period in which a constant current is delivered to the battery (i.e., the charger operating in constant current, or CC mode), the voltage of the battery 12 increases. When the voltage of the battery reached a pre-determined upper limit voltage of, for example, 3.8V (this upper limit voltage is sometimes referred to as the crossover voltage), the charger is configured to maintain the battery's voltage at that upper limit voltage for the remainder of the charging period. During the period that a constant voltage substantially equal to the pre-determined crossover value is applied to the battery 12, the charger 10 is said to be operating in constant voltage, or CV, mode.

The charging operation terminates after a pre-determined period of time has elapsed, e.g., 5 minutes from the commencement of the charging operation. Because the charger is configured to unconditionally terminate the charging operation within a relatively short period of time, during which a significant rise in the temperature of the battery and/or of the charger 10 is unlikely, in some embodiments, it is not necessary to monitor the temperature of the battery 12 and/or the charger 10. Accordingly, in embodiments in which thermal monitoring and control operations are not performed, the charger 10 is more physically compact and the circuitry is simplified.

As further shown in FIG. 1, in some embodiments, the charger 10 is implemented such that current/voltage regulation is performed directly on the charger's power conversion section (e.g., the power conversion module 16 shown in FIG. 1) using, for example, a feedback control mechanism (such a configuration is sometimes referred to as primary-side voltage/current regulation.) In other words, in some embodiments, the control mechanism regulates the switching frequency or pulse duration of the power conversion module 16, thus regulating the output voltage and current of the converter. Accordingly, in such embodiments, the charger 10 does not include multiple voltage conversion stages (e.g., an AC/DC conversion stage followed by, for example, a buck converter circuit), and as a result, the charger 10 can reduce power losses that are generally sustained in multi-stage power conversion circuit. For example, by implementing primary-side voltage/current control, power efficiency (e.g., the percentage of input power ultimately delivered to the output of the power conversion circuit) is typically in the range of 80-90%. In contrast, a two-stage power conversion circuit generally achieve 80-90% efficiency per stage, and thus the overall power efficiency for a two-stage power conversion circuit is generally in the range of 60-80%. These losses in power efficiency are expressed as heat dissipation in the power conversion stages.

The charger 10 includes a rectifier module 14 that is electrically coupled to an AC power source such as a source providing power at a rating of 85V-265V and 50 Hz-60 Hz. In some embodiments, the rectifier module 14 includes a MOSFET based synchronous rectification circuit. The capacitor 15 stores energy for the power conversion module 16.

Coupled to the rectifier module 14 is a power conversion module 16 that includes a transformer 18 and a transformer control unit 20 to facilitate regulating the operation of the transformer 18. In some embodiments, the power conversion module 16 is implemented as a switcher converter in which the desired voltage level at the output of the power conversion module 16 is achieved by switching the power conversion module 16 on and off. During the switcher's on-period, a voltage is provided at the output of the power conversion module 16, and during the off-period, no voltage is provided at output terminals of the power conversion module 16. Such a switcher converter may be implemented, in some embodiments, using discrete transistors (e.g., MOSFET transistors), or using a suitable integrated circuit (IC) to perform the switching operation.

The use of the rectifier module 14 coupled to the power conversion module 16 causes AC power provided at the input to the charger 10 to be converted to a low D.C. voltage suitable for charging rechargeable batteries (e.g., DC voltages at levels of approximately between 3.7-4.2V.)

In some embodiments, an additional DC-DC converter 19 is incorporated into the power conversion module 16 to convert an external DC power source, such as a car's DC power supply, to a DC power level suitable for charging rechargeable batteries. For example, in some embodiments, a car's DC power supply supplies DC power at approximately 11V to 14.4V, and the DC-DC converter 19 converts that voltage level to a suitable voltage level. The added DC-DC converter can be configured to accept almost any DC power source in the range of 1.2V to approximately 24V. Thus, in some embodiments the DC-DC converter is an up-converter, increasing the voltage of 1.2V to the DC charging voltage of 3.7 to 4.2 volts, whereas in those applications above 4.2 voltages the converter is a down converter.

Electrically coupled to the output of the power conversion module 16 is a filter circuit 24 that includes a diode 26 connected in series to a parallel arrangement of a capacitor 28 and a resistor 29 (denoted as Rₛₕ). The filter circuit 24 is configured to reduce current/voltage ripples at the output of the power conversion module 16. The filter circuit 24 is also configured to discharge energy stored in the capacitor 28 into the battery 12 during off-periods when no current is provided at the output of the power conversion module 16. Thus, current provided by the power conversion module 16 during its on-periods and the current provided by the capacitor 28 during the off-periods of the power conversion module 16 results in an effective current substantially equal to a desired charging current to be applied to the battery 12. The diode 26 is connected so that current discharged by the capacitor 28 is directed to the battery 12 and not into the power conversion module 16.

To control the current and/or voltage level applied to the battery 12, a feedback mechanism that includes a controller 30 is used to regulate the DC output voltage of the power conversion module 16. The power conversion module 16 is coupled to the output terminals of charger 10 (and thus to the terminals of the battery 12) through which the charging current is applied. The controller 30 is electrically coupled to a switcher Pulse Width Modulation (PWM) control unit 32 that receives control signals from the controller 30, and generates in response, pulse width modulated signals that are provided to the transformer control unit 20 to cause the power conversion module 16 to provide voltage at its output. When the pulse width modulated signals are withdrawn, the transformer control unit 20 causes the voltage to be withdrawn from the output of the power conversion module 16. Thus, by comparing the current feedback voltage to a pre-set value and controlling the operation of switcher PWM control unit 32, and thus controlling the operation of the power conversion module 16, the controller 30 causes a current substantially equal to the charging current to be applied to the battery 12. The controller 30 is further configured to terminate the charging current after a specified or pre-determined time period has elapsed (e.g., 5 minutes.)

Referring now to FIG. 1A, in some embodiments, the controller 30 may be configured to determine 51 the approximate existing charge level of the battery 12 (e.g., by measuring the voltage of battery), and based on the determined approximate existing charge level, determine 53 a period of time during which a charging current should be applied to the battery 12. The determined charge level is applied to the battery for the determined period of time and thereafter the charger will cease operation. This embodiment provides a flexible timer that self-adjusts charging time according to the existing battery charge. Thus, depending on the initial state of charge of the battery, the charging operation can occur over a period of a minute or less up to about 5 or 6 minutes.

Determination of the charging current to be applied to the battery 12 may be based, at least in part, on user specified input provided through a user interface (not shown) disposed on the charger 10. Such a user interface may include, for example, switches, buttons and/or knobs through which a user may indicate, for example, the capacity of the of battery that is to be recharged. Additionally, in some embodiments the interface may be configured to enable the user to specify other parameter germane to the charging process, such as, for example, the charging period (in circumstances where a longer charging period, e.g., 10-15 minutes, is desired.) To determine the specific charging current to use, a lookup table that indexes suitable charging currents corresponding to the user-specified parameters is accessed. For example, if the user specifics that a 500 mAh capacity lithium-iron-phosphate battery is to be recharged, the entry in the look-up table corresponding to this specified capacity would be retrieved. In some embodiments, computation techniques maybe used to determine the appropriate charging current.

In some embodiments, determination of the charging current may be performed by identifying the capacity battery(s) placed in the charging compartment of the charger 10 using, for example, an identification mechanism that provides data representative of the battery capacity and/or battery type. A detailed description of an exemplary charger device that includes an identification mechanism based on the use of an ID resistor having a resistance representative of the battery's capacity is provided in the concurrently filed patent application entitled “Ultra Fast Battery Charger with Battery Sensing”, the content of which is hereby incorporated by reference in its entirety.

The user interface may also include an input element (e.g., switch) to enable or disable the charger 10. The user interface may also include output indicator devices such as LED's to provide status information to a user regarding the charger and/or battery 12 connected thereto, a display device configured to provide output information to the user, etc. For example, the user interface may include a LED that is illuminated when the charger switches from constant current mode to constant voltage mode. Generally, when the battery's voltage reaches the cross-over point (e.g., between 3.8-4.2V), the battery's charge is typically 80-90% of the battery's charge capacity, and thus is substantially ready for use. The illuminated LED indicates to the user that the battery is at least 80-90% charged, giving the user the option to remove the battery prior to the completion of charging operation if the user requires the battery for some immediate use and does not want to wait for the charging operation to be fully completed.

In some embodiments, the user interface may farther include, for example, additional output devices to provide additional information. For example, the user interface may include a red LED that is illuminated if a fault condition, such as an over-voltage, and may include another LED, e.g., a yellow or green LED device, to indicate that the charging operation of the battery 12 is in progress.

As further shown in FIG. 1, the controller 30 includes a processor device 34 configured to control the charging operations performed on the battery 12. The processor device 26 may be any type of computing and/or processing device, such as a PIC18F1320 microcontroller from Microchip Technology Inc. The processor device 34 used in the implementation of the controller 30 includes volatile and/or non-volatile memory elements configured to store software containing computer instructions to enable general operations of the processor-based device, as well as implementation programs to perform charging operations on the battery 12 connected to the charger, including such charging operations that achieve at least 90% charge capacity in approximately 5 minutes.

The processor 34 includes an analog-to-digital (A/D) converter 36 with multiple analog and digital input and output lines. The A/D converter 36 is configured to receive signals from sensors (described below) coupled to the battery to facilitate regulating and controlling the charging operation. In some embodiments, the controller 30 may also include a digital signal processor (DSP) to perform some or all of the processing functions of the control device, as described herein.

The charger's various modules, including the rectifier unit 14, the transformer control unit 20, the processor 34, and the switcher PWM control unit 32 may be arranged on a circuit board (not shown) of the charger 10.

The charger 10 determines a charging current to be applied to the rechargeable battery 12 such that the battery 12 is charged to, e.g., approximately 80%-95% charge capacity of the battery 12 in approximately 4-6 minutes. As explained herein, batteries based on lithium-iron-phosphate electrochemical cells have relatively low internal resistance and thus can be charged with relatively large charging currents in the order of, for example, 10 C to 15 C, where a charge rate of 10 C correspond to a charge current that would charge a rechargeable battery in 6 minutes (1 C being the current required to charge a particular rechargeable battery in 1 hour), and a current of 15 C is the current required to charge die rechargeable battery in 4 minutes. Because of the low charging resistance of lithium-iron-phosphate batteries, significant heat dissipation is avoided and accordingly such batteries can withstand high charging currents without the battery's performance or durability being adversely affected.

The transistor's on-period, or duty cycle, is initially ramped up from 0% duty cycle, while the controller or feedback loop measures the output current and voltage. Once the determined charging current is reached, the feedback control loop manages the transistor duty cycle using a closed loop linear feedback scheme, e.g., using a proportional-integral-differential, or PID, mechanism. A similar control mechanism may be used to control the transistor's duty cycle once the charger voltage output, or battery terminal voltage, reaches the crossover voltage.

Thus, the current provided by the power conversion module 16 during its on-period, and the current provided by the capacitor 28 during the off-periods of the power conversion module 16 should result in an effective current substantially equal to the required charging current.

In some embodiments, controller 30 periodically receives (e.g., every 0.1 second) a measurement of the current flowing through the battery 12 as measured, for example, by a current sensor 40. Based on this received measured current, the controller 30 adjusts the duty cycle to cause an adjustment to the current flowing through the battery 12 so that that current converges to a value substantially equal to the charging current level. The current sensor 40 is also used to periodically measure the battery's current during the constant current stage of the charging process to enable the controller 30 to regulate the current provided by the power conversion module 16 such that the charging current applied to the battery 12 is at a substantially constant level.

The charger 10 also includes a voltage sensor 42 that is electrically coupled to the charging terminals of the charger 10. The voltage sensor periodically measures (e.g., every 0.1 seconds) the voltage at the terminals of the battery 12, particularly during the constant voltage stage of the charging process. These periodical voltage measurements enable the controller 30 to control the voltage provided by the power conversion module 16 during the constant voltage (CV) stage so that the voltage applied at the terminals of the battery 12 during the CV stage is at a substantially constant level (e.g., the pre-determined upper-limit voltage.)

The current/voltage measured by the sensors 40 and 42 may be used to determine if fault conditions exist that require that the charging operation of be terminated, or that the charging operation not be commenced. For example, the controller 30 determines if the voltage measured, by the voltage sensor 42 at the terminals of the battery 12 is within a predetermined range of voltage levels for the battery 12 (e.g., 2 to 3.8V). If the measured value is below the lower voltage limit of the range, this may be indicative that the battery is defective. If the measured value is above the upper limit of the range, this could be indicative that the battery is already folly charged and thus further charging is not required and might damage the battery. Accordingly, if the measured voltage does not fail within the pre-determined range, a fault condition is deemed to exist.

The charger may make a similar determination with respect to the current measured via the current sensor 40, and if the measured current is outside a pre-determined current range, a fault condition may be deemed to exist, and consequently the charging operation would either not be commenced, or would be terminated.

In some embodiments, the received measured signals are processed using analog logic processing elements (not shown) such as dedicated charge controller devices that may include, for example, threshold comparators, to determine the level of the voltage and current level measured by the sensors 40 and/or 42. The charger 10 may also include a signal conditioning block (not shown) for performing signal filtering and processing on analog and/or digital input signals to prevent incorrect measurements (e.g., incorrect measurements of voltages, temperatures, etc.) that may be caused by extraneous factors such as circuit level noise.

In some embodiments, the controller 30 is configured to monitor the voltage increase rate by periodically measuring the voltage at the terminals of the battery 12, and adjust the charging current applied to the battery 12 such that the pre-determined upper voltage limit is reached within some specified voltage rise period of time. Based on the measured voltage increase rate, the charging current level is adjusted to increase or decrease the charging current such that the pre-determined upper voltage limit is reached within the specified voltage rise period. Adjustment of the charging current level is performed, for example, in accordance with a predictor-corrector technique that uses a Kalman filter. Other approaches for determining adjustments to the current to achieve the pre-determined upper voltage limit may be used.

Because the charger described, herein charges batteries, e.g. lithium-iron-phosphate batteries, over a relatively short interval (e.g., 5 minutes), such a charger typically would not generate significant heat during that period of operation. Therefore, certain modules and/or components configured to safeguard the operation of conventional chargers to prevent damage and unsafe operation due to the generation of heat maybe eliminated from the charger. For example, the charger 10 may be constructed without employing thermal control components (e.g., fans, heat sink elements, additional control modules, etc.) and/or without thermal monitoring components (e.g., thermal sensors such as thermistors).

Further, because of the short period of operation of the charger described herein, the physical dimensions of the various components of the charger, which frequently are configured to have large surface areas to dissipate generated heat, may be smaller than the components used with conventional chargers. Consequently, such smaller size components may be fitted into a smaller size housing, thus resulting in charger devices having physical dimensions that are generally smaller than those of conventional charger devices.

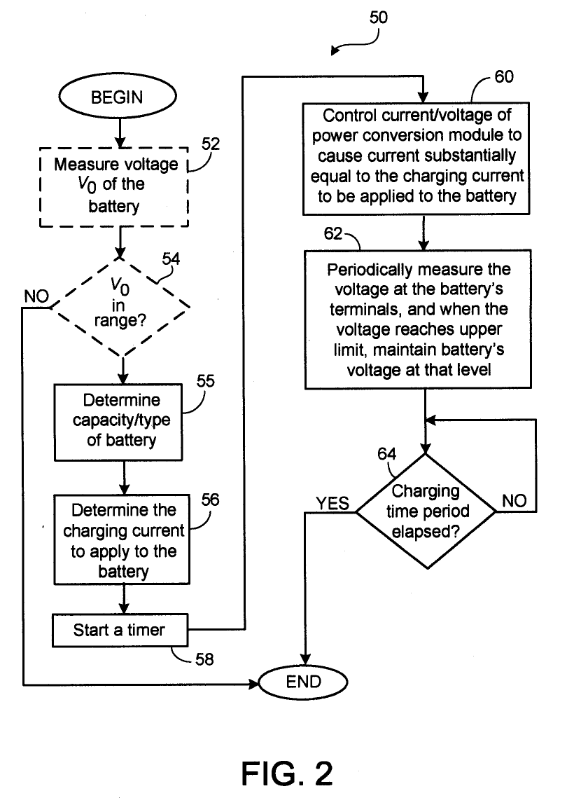

FIG. 2 depicts an exemplary embodiment of a charging procedure 50 to recharge the rechargeable battery 12 placed in the charging compartment of the charger 10. After placing the battery 12 in the charger's charging compartment, the charger 10 may optionally determine, prior to commencing the charging operations, whether certain fault conditions exist. Thus, for example, the charger 10 measures 52 the voltage of the battery 12. The charger 10 determines 54 whether the measured voltage V₀ is within a predetermined range (e.g., that V₀ is between 2-3.8V.) In circumstances in which it is determined that the measured voltage is not within the predetermined acceptable ranges thus rendering a charging operation under current conditions to be unsafe, the charger does not proceed with the charging operation, and the procedure 50 may terminate.

The charger 10 determines 56 a charging current to be applied to the battery 12 such that the battery 12 will achieve at least a 90% charge capacity in approximately 4-6 minutes. If the charger 10 is adapted to receive and charge only one type of battery of a particular capacity (e.g., a lithium-iron-phosphate battery with a capacity of 500 mAh), the charger applies a pre-specified charging current corresponding to this type of battery to the battery 12 (e.g., a charging current of 6 A would charge a 500 mAh battery within approximately 5 minutes.)

If the charger 10 is adapted to receive different types of batteries of different capacities, then the charger 10 may determine 55 the capacity and/or type of the battery 12 inserted into the charging compartment of the charger 10. In some embodiments, the charger 10 includes an identification mechanism configured to measure the resistance of an ID resistor connected to the battery 12 that is representative of the capacity and/or type of the battery 12. Additionally and/or alternatively, the capacity and/or type of the battery 12 may be communicated to the charger via a user interface disposed, for example, on the body of the charger 10. The data communicated via the identification mechanism, user interface, or otherwise, is thus representative of the battery's capacity and/of type. The charger can thus determine the appropriate charging current to apply to the battery based on this data. For example, in circumstances where the charger 10 computes the resistance of an ID resistor of the battery 12, the charger 10 may access a lookup table stored on a memory storage module of the charger 10 that indexes suitable charging currents corresponding to the capacity associated with the computed resistance.

Having determined the charging current to be applied to battery 12, a timer, configured to measure the pre-specified time period of the charging operation, is started 58. The timer may be, for example, a dedicated timer module of the processor 34, or it may be a counter that is incremented at regular time intervals measured by an internal or external clock of the processor 34.

The current/voltage applied by the power conversion module 16 is controlled 60 to cause a constant current substantially equal to the determined charging current to be applied to the rechargeable battery 12. As explained, the charger 10 implements a primary-side feedback mechanism that includes the controller 30 and the switcher PWM control unit 32, that operates to adjust the current/voltage at the output of the power conversion module 16. During the off-time of the power conversion module 16 (i.e., when current/voltage at the output of the module 16 is withheld), the energy stored in the capacitor 28 is discharged to the battery 12 as a current. The combined current applied from the power conversion module 16, and the current discharged from the capacitor 28 result in an effective current substantially equal to the determined charging current.

The battery 12 is charged with substantially a constant current until the voltage at the battery's terminals reaches a pre-determined upper voltage limit. Thus, the voltage applied to the battery 12 is periodically measured 62 to determine when the pre-determined upper voltage limit (i.e., the crossover voltage) has been reached. When the voltage at the terminals of the battery 12 has reached the pre-determined upper voltage limit, e.g., 4.2V, the power conversion module 16 is controlled (also at 62) to have a constant voltage level substantially equal to the crossover voltage level maintained at the terminals of the battery 12.

Additionally, a LED on the user interface of the charger 10 may illuminate to indicate that the crossover voltage point has been reached, and that therefore the battery has sufficient charge to properly operate. At that point a user may remove the battery 12 if the user desires to immediately use the battery.

The voltage increase rate may be periodically measured (operation not shown in FIG. 2) to cause the pre-determined upper voltage limit to be reached within the specified voltage rise period of time. Based on the measured voltage increase rate, the charging current level is adjusted (with a corresponding adjustment of the actuating signal applied to the current/voltage regulating circuit) to increase or decease the charging current such that the pre-determined upper voltage limit is reached within the specified voltage rise period.

After a period of time substantially equal to the charging time period has elapsed, as determined 64, the charging current applied to the battery 12 is terminated (for example, by ceasing electrical actuation power conversion module 16 using the switcher PWM control module 32 and/or the transformer control unit 20). The charging procedure is terminated at the expiration of a particular period of time after the pre-determined upper voltage limit of the battery 12 has been reached, or after some specified charge level of the battery 12 has been reached.

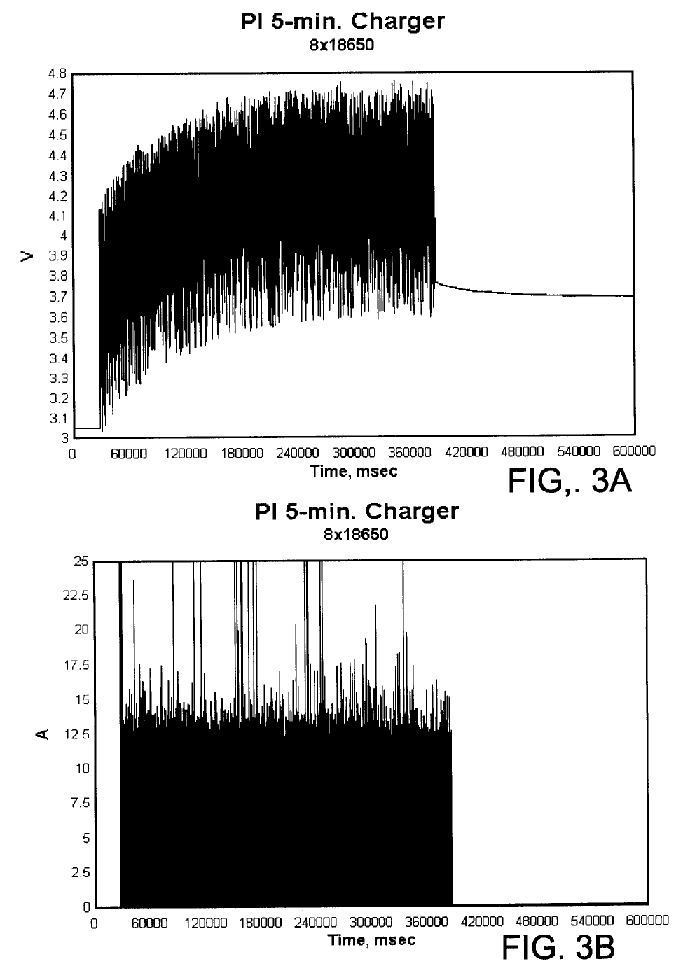

FIGS. 3A and 3B illustrate exemplary charging voltage and charging current behaviors, respectively, for a 1 Ah lithium-iron-phosphate battery subjected to 5-minute charge at 4.2V CV/12 A CC using a charger of the type shown in FIG. 1. As shown in FIG. 3B, upon commencement of the charging operation, a constant current of approximately 12 A is applied to the battery. At a charging current of 12 A, a 1 Ah battery would become fully charged (if it were substantially entirely depleted) in approximately 5 minutes (1 Ah/12 A=0.0833 h=5 minutes.)

As explained, the charger is configured to cause a substantially constant current to be produced and applied to the battery 12, and therefore, in response to fluctuations in the current (as shown by the spikes appearing in the graph) the charger will cause the average charging current to be maintained constant at approximately 12 A. When the charging current is first applied, the voltage at the charging terminals of the charger and/or the battery 12 is approximately 3.7V. The voltage begins to increase and reaches an average level of 4.2V about 3 minutes later. Thereafter, the voltage at the charging terminals is maintained at the level.

### Other Embodiments

A number of embodiments of the invention have been described. Nevertheless, it will be understood that various modifications may be made without departing from the spirit and scope of the invention. For instance, the charger can be associated with or embedded within a docking station used with an electronic device, e.g., cell phone, computer, personal digital assistant and so forth. Accordingly, other embodiments are within the scope of the following claims.

1. A method for charging a rechargeable battery, the method comprising:
determining a current level to apply to the rechargeable battery such that the battery has a pre-determined charge that is reached within a charging period of time of between 4-6 minutes;
applying a charging current having substantially about the determined current level to battery; and
terminating the charging current after a period of charging time substantially equal to the particular period of time has elapsed.

2. The method of claim 1, further comprising:
periodically adjusting the charging current after a pre-determined voltage level at terminals of the rechargeable battery is reached to maintain the voltage between terminals of the rechargeable battery at the pre-determined voltage level.

3. The method of claim 2, further comprising:
causing an output indicator device to be activated when the pre-determined voltage level at terminals of the rechargeable battery is reached.

4. The method of claim 1, wherein the pre-determined charge of the cell is at least 80% of the charge capacity of the rechargeable battery, and wherein the charging period of time is approximately 3-4 minutes.

5. The method of claim 3, wherein the pre-determined charge of the rechargeable battery is at least 90% of the charge capacity of the rechargeable battery, and wherein the charging period of time is approximately 5 minutes.

6. The method of claim 1, wherein applying the charging current is performed without monitoring temperatures of the rechargeable battery.

7. The method of claim 1, wherein applying the charging current comprises regulating current provided by a power conversion module having a voltage transformer section.

8. The method of claim 7, wherein regulating the current provided by the power conversion module includes regulating the operation of the voltage transformer section.

9. The method of claim 1, wherein determining the current level to apply to the rechargeable battery comprises determining the current level to apply to a rechargeable lithium-iron-phosphate-based battery.

10. A charger device to charge one or more rechargeable batteries, the device comprising:
a receptacle to receive one or more rechargeable batteries, the receptacle having electrical contacts configured to be coupled to respective terminals of the one or more rechargeable batteries; and
a controller configured to:
determine a current level to apply to the one or more rechargeable batteries such that the one or more batteries have a pre-determined charge that is reached within a charging period of time of between 4-6 minutes;
apply a charging current having substantially about the determined current level to the one or more rechargeable batteries; and
terminate the charging current after a period of charging time substantially equal to the particular period of time has elapsed.

11. The device of claim 10, wherein the pre-determined charge of the one or more batteries is at least 80% of the charge capacity of the one or more cells, and wherein the charging period of time is approximately between 3-15 minutes.

12. The device of claim 11, wherein the pre-determined charge of the one or more rechargeable batteries is approximately 80% of the charge capacity of the one or more batteries, and wherein the charging period of time is approximately between 3-4 minutes.

13. The device of claim 12, wherein the pre-determined charge of the one or more rechargeable batteries is at least 90%-95% of the charge capacity of the one or more batteries, and wherein the specified period of time is approximately 5 minutes.

14. The device of claim 10, further comprising a power conversion module the power conversion module comprising a voltage transformer.

15. The device of claim 14, wherein the device comprises a feedback control mechanism to cause the controller to regulate current outputted by the power conversion module.

16. The device of claim 15, wherein the feedback control mechanism is configured to regulate the operation of the voltage transformer.

17. The device of claim 15, wherein the feedback control mechanism is configured to maintain the voltage at the terminals of the one or more rechargeable batteries at a pre-determined upper limit voltage, after the voltage at the one or more batteries reach the pre-determined upper-limit voltage level.

18. The device of claim 17, further comprising an output indicator device, with the controller configured to cause the output indicator device to be activated when the pre-determined voltage level at terminals of the rechargeable battery is reached.

19. The device of claim 10, further comprising a MOSFET-transistor-based synchronous rectifier.

20. The device of claim 10, wherein the controller is configured to determine the current level to apply to one or more lithium-iron-phosphate-based rechargeable batteries.

21. The device of claim 10, wherein the controller includes a processor-based micro-controller.

22. The device of claim 10, wherein the controller configured to apply the charging current is configured to apply the charging current performed without monitoring temperatures of the one or more rechargeable batteries.

23. A charger device comprising:
electrical contacts configured to couple to respective terminals of one or more rechargeable batteries;
circuitry to charge the one or more batteries by applying a constant charging current to the one or more rechargeable batteries upon commencement of the charging operation and to maintain a constant voltage on the one or more batteries when the voltage of the one or more batteries reaches a pre-determined upper limit voltage; and
a controller configured to control the circuitry, the controller configured to:
cause the circuitry to charge to the battery for charging period of time of between 4-6 minutes and to thereafter terminate charging of the battery.

24. A charger device comprising:
electrical contacts configured to couple to respective terminals of one or more rechargeable batteries; and
circuitry to charge the one or more batteries by measuring existing charge in the battery, determining a period of time over which to apply charging current, applying a charging current to the one or more rechargeable batteries upon commencement of the charging operation over the determined charging period of time.
